(19) United States
(12) Patent Application Publication
(10) Pub. No.: US 2006/0055740 A1
(43) Pub. Date: Mar. 16, 2006

(54) Inkjet recording head, inkjet printer, and droplet jetting apparatus

(75) Inventor: Yoshinao Kondoh, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/049,173

(22) Filed: Feb. 2, 2005

(30) Foreign Application Priority Data
Sep. 16, 2004 (JP) 2004-269517

(51) Int. Cl. B41J 2/045

(52) U.S. Cl. 347/68

(57) ABSTRACT

An inkjet recording head includes an ejector substrate in which plural droplet ejectors are arranged. Each droplet ejector includes a pressure chamber that houses ink, a drive element that acts on the ink in the pressure chamber to generate pressure waves and a nozzle which communicates with the pressure chamber and through which ink droplets are jetted. A drive circuit substrate is disposed facing the ejector substrate and includes drive circuits that drive the drive elements to cause the ink droplets to be jetted from the nozzles. The ejector substrate and the drive circuit substrate are connected by elastic conductive members.

### CROSS-REFERENCE TO RELATED APPLICATION

This application claims priority under 35 USC 119 from Japanese Patent Application No. 2004-269517, the disclosure of which is incorporated by reference herein.

### BACKGROUND OF THE INVENTION

1. Field of the Invention

The present invention relates to an inkjet recording head where drive elements act on ink inside pressure chambers to generate pressure waves and cause ink droplets to be jetted from nozzles. The present invention also relates to an inkjet printer and a droplet jetting apparatus which are disposed with this inkjet recording head.

2. Description of the Related Art

Conventionally, inkjet recording apparatus that jet ink droplets from plural nozzles to conduct printing on a recording medium such as paper have had advantages, such as being compact, inexpensive and quiet, and have been widely commercially available.

One such inkjet recording apparatus utilizes a piezo-inkjet method where by pressure from piezoelectric elements acts on ink in pressure chambers to generate pressure waves and cause ink droplets to be jetted from nozzles. This piezo-inkjet method has many advantages in that high-speed printing and high resolution are obtained.

Such inkjet recording apparatus are disposed with an ejector substrate in which plural droplet ejectors disposed with one nozzle and pressure chamber are two-dimensionally arranged. The ejector substrate is connected to a drive circuit substrate by flexible cables, and the individual droplet ejectors are driven as a result of a voltage being applied. When the flexible cables are configured by single-layer cables, the wires cannot be crossed, and high densification is difficult even if the cables are made into thin wires and the pitch is narrowed. Also, because the flexible cables are made of synthetic resin, it is difficult to ensure the precision of connection positions due to expansion and contraction. When the flexible cables are configured by multilayer cables, crossing is possible with through holes, but the dimension of the through holes becomes large and it becomes difficult to narrow the pitch. Also, the cost ends up significantly increasing with multilayer cables.

With respect thereto, an inkjet recording head has been proposed where the ejector substrate and the drive circuit substrate are made to face each other and thermo-compressed to form a rigid connection (e.g., see Japanese Patent Application Laid-Open Publication (JP-A) No. 11-78003).

In this inkjet recording head, the ejector substrate and the drive circuit substrate are thermo-compressed and fixed. Thus, when electrode pads are disposed on the upper portions of diaphragms of the pressure chambers, displacement of the diaphragm ends up being restricted. For this reason, the electrode pads must be disposed somewhere other than on the upper portions of the pressure chambers, the area of the ejector substrate increases, the load capacity and current increase, and the energy efficiency is reduced. Also, because the ejector substrate in which the droplet ejectors are two-dimensionally arranged has a complicated flow path structure, the rigidity becomes small and the ejector substrate ends up being deformed at the time of maintenance. For this reason, stress is concentrated at the portions where the ejector substrate and drive circuit substrate are rigidly fixed and connected, and problems in the connections (e.g., disconnections, etc.) arise.

### SUMMARY OF THE INVENTION

The present invention has been made in view of the above problems and provides an inkjet recording head and an inkjet printer where the portions where the ejector substrate and the drive circuit substrate are electrically connected are compacted and whose energy efficiency is high.

An inkjet recording head pertaining to a first aspect of the invention includes: an ejector substrate in which plural droplet ejectors are arranged, with each droplet ejector including a pressure chamber that houses ink, a drive element that acts on the ink in the pressure chamber to generate pressure waves and a nozzle which communicates with the pressure chamber and through which ink droplets are jetted; a drive circuit substrate that is disposed facing the ejector substrate and includes drive circuits that drive the drive elements to cause the ink droplets to be jetted from the nozzles; and elastic conductive members that connect the ejector substrate and the drive circuit substrate.

In the first aspect of the invention, droplet ejectors that jet ink droplets from nozzles are plurally arranged on an ejector substrate. A drive circuit substrate is disposed facing the ejector substrate, and the ejector substrate and the drive circuit substrate are connected by elastic conductive members. When a voltage is applied from the drive circuit substrate through the elastic conductive members to the ejector substrate, pressure waves act on the ink inside the pressure chambers due to the drive elements of the droplet ejectors, and ink droplets are jetted from nozzles. In this case, the ejector substrate is not restricted to the drive circuit substrate by the elastic conductive members, so that when the drive elements are driven, the operation of the droplet ejectors is not restricted. Thus, the degree of freedom with which the ejector substrate and the drive circuit substrate are connected increases, whereby the area of the ejector substrate can be reduced, and a reduction in energy efficiency resulting from an increase in the current and load capacity can be prevented.

An inkjet printer pertaining to a second aspect of the invention is disposed with an inkjet recording head that includes: an ejector substrate in which plural droplet ejectors are arranged, with each droplet ejector including a pressure chamber that houses ink, a drive element that acts on the ink in the pressure chamber to generate pressure waves and a nozzle which communicates with the pressure chamber and through which ink droplets are jetted; a drive circuit substrate that is disposed facing the ejector substrate and includes drive circuits that drive the drive elements to cause the ink droplets to be jetted from the nozzles; and elastic conductive members that connect the ejector substrate and the drive circuit substrate.

A droplet jetting apparatus pertaining to a third aspect of the invention includes: an ejector substrate in which plural droplet ejectors are arranged, with each droplet ejector including a pressure chamber that houses ink, a drive element that acts on the ink in the pressure chamber to generate pressure waves and a nozzle which communicates with the pressure chamber and through which ink droplets are jetted; a drive circuit substrate that is disposed facing the ejector substrate and includes drive circuits that drive the drive elements to cause the ink droplets to be jetted from the nozzles; and elastic conductive members that connect the ejector substrate and the drive circuit substrate.

Because the present invention is configured as described above, the portions where the ejector substrate and the drive circuit substrate are electrically connected are compacted, and the area of the ejector substrate can be reduced. Moreover, an inkjet recording head, an inkjet printer and a droplet jetting apparatus whose energy efficiency is high can be realized.

### BRIEF DESCRIPTION OF THE DRAWINGS

FIG. 1 is a perspective view showing an inkjet recording head pertaining to a first embodiment of the invention;

FIG. 2 is a plan view showing ejector substrates of head units configuring the inkjet recording head shown in FIG. 1;

FIG. 3 is a plan view showing a nozzle surface of a head unit configuring the inkjet recording head shown in FIG. 1;

FIG. 4 is a cross-sectional view showing conductive members that connect a drive circuit substrate and the ejector substrate of the head unit configuring the inkjet recording head shown in FIG. 1;

FIG. 5 is a perspective view showing relevant portions of an inkjet recording apparatus disposed with the inkjet recording head shown in FIG. 1;

FIGS. 6A to 6E are diagrams describing a method of manufacturing the conductive members connecting the drive circuit substrate and the ejector substrate of the head unit configuring the inkjet recording head shown in FIG. 1; and

FIGS. 7A and 7B are diagrams describing a method of manufacturing the conductive members connecting the drive circuit substrate and the ejector substrate of the head unit configuring the inkjet recording head pertaining to a second embodiment of the invention.

### DETAILED DESCRIPTION OF THE INVENTION

A first embodiment of the invention will be described in detail below on the basis of the drawings.

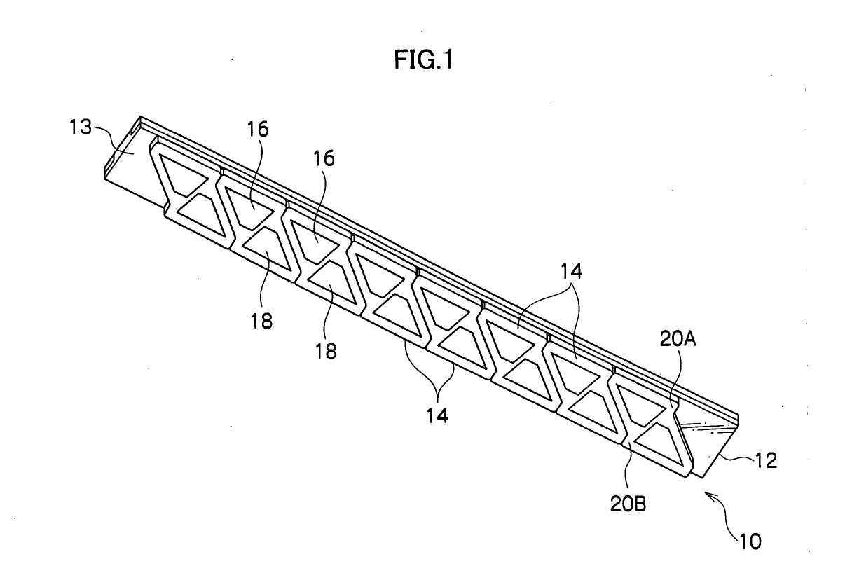

FIG. 1 is a schematic perspective view showing an inkjet recording head 10 that is the first embodiment of the invention.

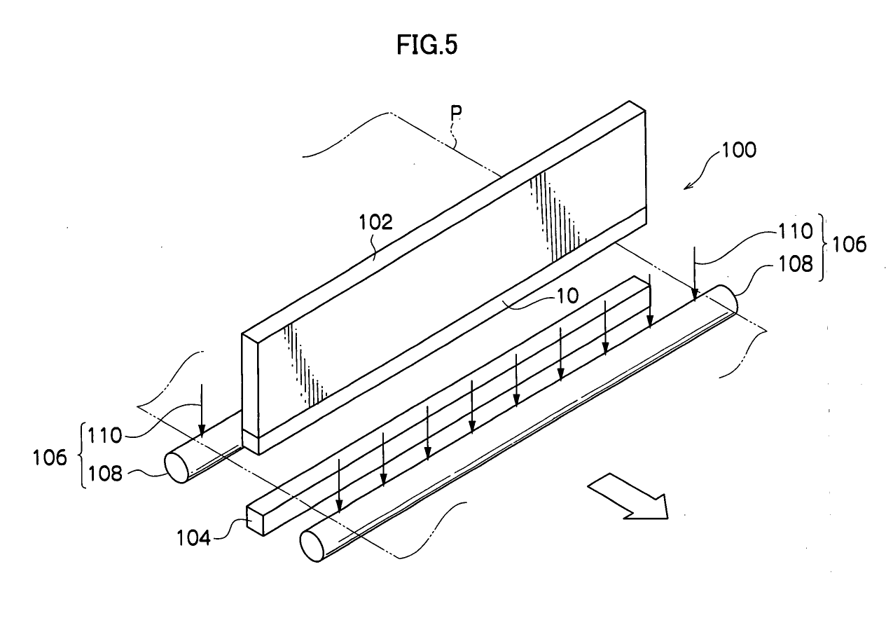

As shown in FIG. 1, the inkjet recording head 10 is disposed with a head bar 12 set to a length corresponding to the maximum width of a recording medium P (see FIG. 5). Plural head units 14 are connected in a line to, and two-dimensionally arranged on, a support member 13 of the head bar 12. The head units 14 are attached to the support member 13 with screws (not shown), so that each head unit 14 can be individually replaced.

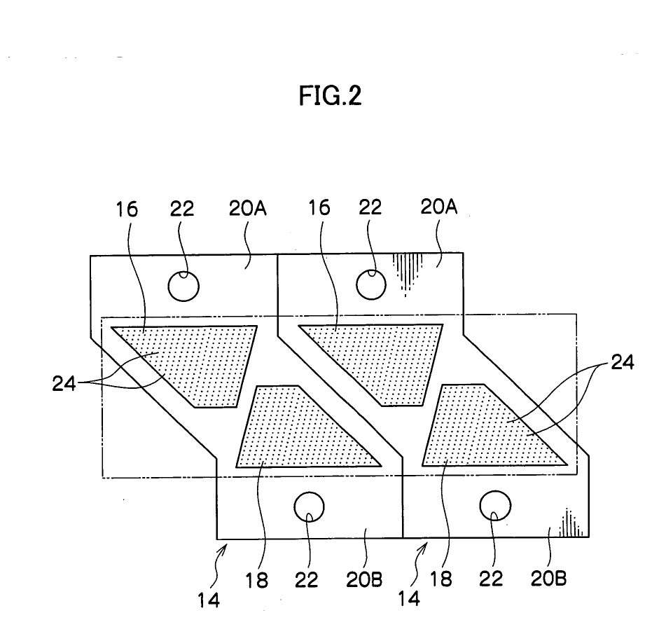

As shown in FIG. 2, each head unit 14 includes a substantially parallelogram-shaped portion. End portions of this substantially parallelogram-shaped portion linearly project outward (i.e., in a direction orthogonal to the opposite sides of the central portion having the substantial parallelogram shape) to form extension portions 20A and 20B. Two ejector substrates 16 and 18 comprising a group of droplet ejectors are disposed in the substantially parallelogram-shaped portion of each head unit 14. The two ejector substrates 16 and 18 are substantially trapezoidal and disposed in the head unit 14 so that oblique sides of the same length of the substantially trapezoidal shapes (in the present embodiment, the short oblique sides) face each other. An ink supply port 22 for supplying ink to the ejector substrates 16 and 18 is disposed at both sides of each head unit 14.

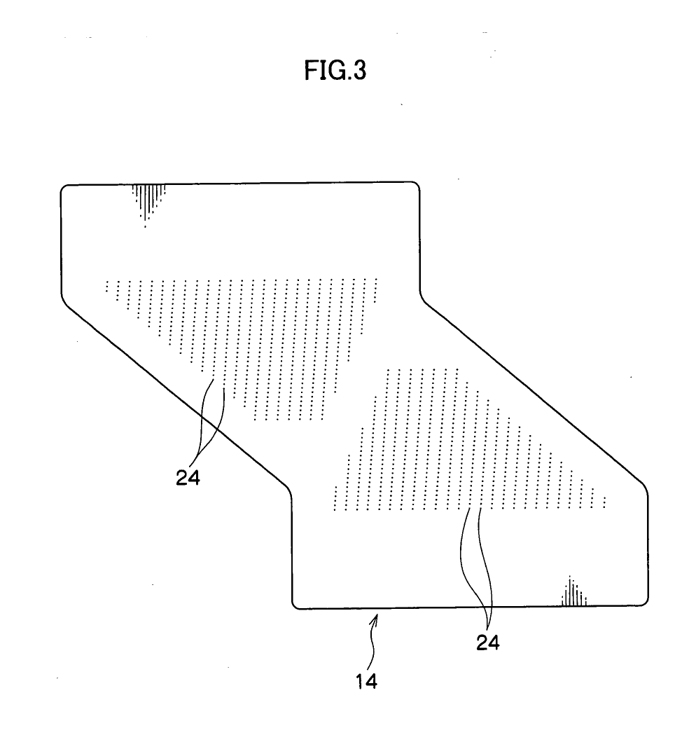

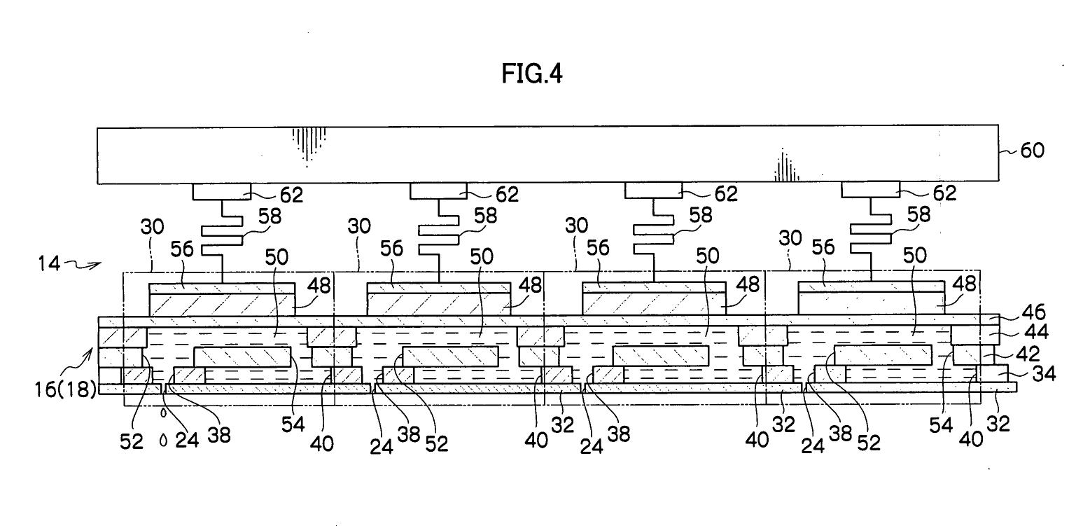

As shown in FIG. 4, numerous droplet ejectors 30 are two-dimensionally disposed in the two ejector substrates 16 and 18, and one nozzle 24 is disposed in each droplet ejector 30. Namely, as shown in FIG. 3, plural nozzles 24 are formed in correspondence to the ejector substrates 16 and 18 on the surface of the head unit 14. For example, 512 of the droplet ejectors 30 are two-dimensionally disposed in 32 stages in the ejector substrates 16 and 18, and are asymmetrical at the left and right. The droplet ejectors 30 are disposed so that when all of the droplet ejectors 30 are driven to print one line, they do not overlap.

As shown in FIG. 5, when the inkjet recording head 10 is disposed in an inkjet recording apparatus 100, the inkjet recording head 10 is disposed on a support base 102 so that the nozzles 24 of the head units 14 (see FIG. 3) face down. The relevant portions of the inkjet recording apparatus 100 are configured by the inkjet recording head 10, a maintenance device 104 disposed facing the inkjet recording head 10, and conveyance mechanism 106 that convey the recording medium P between the inkjet recording head 10 and the maintenance device 104 in the direction of the arrow.

The inkjet recording head 10 includes a printing region corresponding to the maximum width of the recording medium P as a result of the head units 14 (see FIG. 1) being disposed in a line, and can print across the entire width of the recording medium P without scanning the inkjet recording head 10. Namely, the inkjet recording head 10 has a configuration where printing is completed simply by the recording medium P passing below the inkjet recording head 10 one time.

The conveyance mechanism 106 are disposed at different positions from the inkjet recording head 10 in the conveyance direction of the recording medium P. This is because the maintenance device 104 is disposed at a position facing the inkjet recording head 10. The conveyance mechanism 106 are configured by, for example, conveyance rollers 108 that contact the underside of the recording medium P and apply a driving force to the recording medium P and urging mechanism 110 that push the recording medium P against the conveyance rollers 108. With respect to the urging mechanism 110, a configuration where urging members directly contact and urge the recording medium P, or a configuration where urging members do not directly contact the recording medium P, is applicable. Examples of the latter include the blowing of air, which is effective in that the urging mechanism 110 do not contact the printed recording medium P. Although not illustrated, the maintenance device 104 is configured by a cap member that caps the nozzles 24 of the inkjet recording head 10 and a wiping member that cleans the nozzles 24.

As shown in FIG. 4, the plural nozzles 24 are formed in a nozzle plate 32 in the ejector substrates 16 and 18 configuring the head units 14. A flow path forming plate 34, a through hole plate 42, a pressure chamber plate 44 and a diaphragm (first electrode) 46 are positioned and layered above the nozzle plate 32, and joined by bonding means such as an adhesive or the like.

Plural through holes 38 that communicate with the nozzles 24 are formed in the flow path forming plate 34. Plural through holes 52 are also formed in the through hole plate 42. The nozzles 24, the through holes 38 and the through holes 52 communicate with each other and lead to pressure chambers 50 formed in the pressure chamber plate 44.

Plural ink pools 40 are formed in the flow path forming plate 34 and are configured so that ink is supplied from the ink supply ports 22 shown in FIG. 2. Plural supply holes 54 are formed in the through hole plate 42 so as to connect to the ink pools 40. The ink pools 40, the supply holes 54 and the pressure chambers 50 communicate with each other in a state where the flow path forming plate 34, the through hole plate 42 and the pressure chamber plate 44 are laminated.

The pressure chambers 50 are disposed in each droplet ejector 30. A piezoelectric element 48 is disposed above each pressure chamber 50 above the diaphragms 46. An electrode pad (second electrode) 56 is disposed above each piezoelectric element 48.

A drive circuit substrate 60 that drives the ejector substrates 16 and 18 is disposed facing the upper portions of the ejector substrates 16 and 18. Electrode terminals 62 are disposed at positions on the drive circuit substrate 60 facing the piezoelectric elements 48. The electrode terminals 62 and the electrode pads 56 are connected by elastic conductive members 58. A large area semiconductor substrate such as SOG (System on Glass) or a printed substrate where small area semiconductor substrates (drive ICs) are plurally mounted is used for the drive circuit substrate 60. The drive circuit substrate 60 and the ejector substrates 16 and 18 are attached to unillustrated support members, so that the conductive members 58 are not given the role of supporting the drive circuit substrate 60 or the ejector substrates 16 and 18.

The conductive members 58 are formed in zigzag or crenellated shapes and are expandable/contractible in the vertical direction of FIG. 4, i.e., in the normal line direction of the ejector substrates 16 and 18.

Next, a method of manufacturing the elastic conductive members 58 that connect the ejector substrates 16 and 18 and the drive circuit substrate 60 will be described.

The conductive members 58 are manufactured using a semiconductor manufacturing process, for example. A material that can be used in plating, such as copper, gold or nickel, is used for the material of the conductive members 58. With a manufacturing method resulting from plating, high-speed film formation is possible.

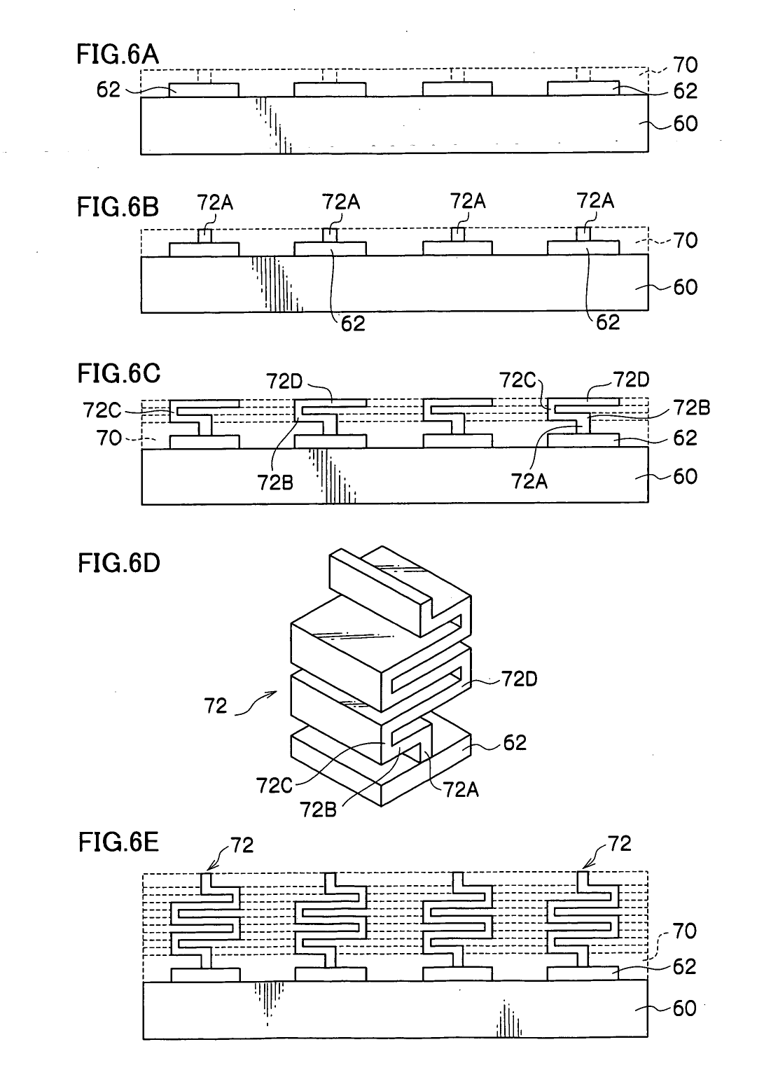

As shown in FIG. 6A, the drive circuit substrate 60 is used for a base. It will be noted that a dummy base or the ejector substrates 16 and 18 may also be used for the base.

The electrode terminals 62 are laminated on the drive circuit substrate 60, and then a sacrifice layer 70 comprising a metal is formed. Then, the sacrifice layer 70 is patterned via an unillustrated mask, and as shown in FIG. 6B, unwanted portions are removed, and conductive layers 72 are formed and planarized. Next, as shown in FIG. 6C, conductive layers 72B, 72C and 72D are successively formed on each sacrifice layer 70 by repeating the formation and patterning of sacrifice layers 70 and the formation and planarization of conductive layers 72. At this time, as shown in FIG. 6D, the conductive layers 72A, 72B, 72C and 72D are laminated in zigzag shapes, whereby continuous conductive members 72 are formed. The film thickness of each sacrifice layer 70 and conductive layer 72 is about 20 μm or less, and several tens of layers are laminated (in FIGS. 6A to 6E, conductive members where the number of laminates has been reduced is shown for ease of description).

Then, as shown in FIG. 6E, after all of the sacrifice layers 70 and the conductive layers 72 have been laminated, the sacrifice layers 70 are removed at once, whereby conductive members 58 comprising zigzag conductive layers 72 are completed. Because the conductive members 58 are formed in zigzag shapes, they expand and contract in the normal line direction of the drive circuit substrate 60, and flexibility of about 1 mm is obtained.

It will be noted that the uppermost layer or the lowermost layer (corresponding to the electrode terminals) may have a planar pattern within the terminal area of the drive circuit substrate 60 and the ejector substrates 16 and 18.

The conductive members 58 are not limited to the manufacturing method shown in FIGS. 6A to 6E, and may also be manufactured in an order where forming and patterning the conductive layers 72, removing the unwanted portions, and forming and planarizing the sacrifice layers are repeated.

Next, the action of the inkjet recording head 10 will be described.

In the head units 14 of the inkjet recording head 10, ink flow paths are formed which continue from the ink pools 40 to the supply holes 54, the pressure chambers 50, the through holes 52, the through holes 38 and the nozzles 24. The ink supplied from the ink supply ports 22 and retained in the ink pools 40 fills the insides of the pressure chambers 50 via the supply holes 54. Then, a drive voltage is applied from the electrode terminals 62 of the drive circuit substrate 60 to the individual piezoelectric elements 48 through the conductive members 58. When the drive voltage is applied to the piezoelectric elements 48, the diaphragms 46 are elastically deformed together with the piezoelectric elements 48 to cause the pressure chambers 50 to expand or contract. Thus, volumetric changes arise in the pressure chambers 50, and pressure waves are generated inside the pressure chambers 50. The ink moves as a result of the action of the pressure waves, and ink droplets are jetted from the nozzles 24 to the outside.

At this time, the conductive members 58 expand and contract in the plate thickness direction (normal line direction) of the ejector substrates 16 and 18 as a result of the deformation of the piezoelectric elements 48 and the diaphragms 46. The drive circuit substrate 60 and the ejector substrates 16 and 18 are attached to the unillustrated support members and are maintained in a support state where they do not restrict each other. For this reason, they do not restrict the deformation of the piezoelectric elements 48 and the diaphragms 46. Thus, the amount of deformation of the piezoelectric elements 48 and the diaphragms 46 can be prevented from being reduced, and the energy efficiency rises.

In the inkjet recording head 10, the droplet ejectors 30 are two-dimensionally disposed and the electrode pads 56 can be disposed on the piezoelectric elements 48 above the diaphragms 46. Thus, the electrode pads 56 can be efficiently disposed on the ejector substrates 16 and 18. Thus, the area of the ejector substrates 16 and 18 can be prevented from increasing, and an inkjet recording head 10 that is compact and highly dense can be realized.

Next, conductive members used in an inkjet recording head of a second embodiment of the invention will be described.

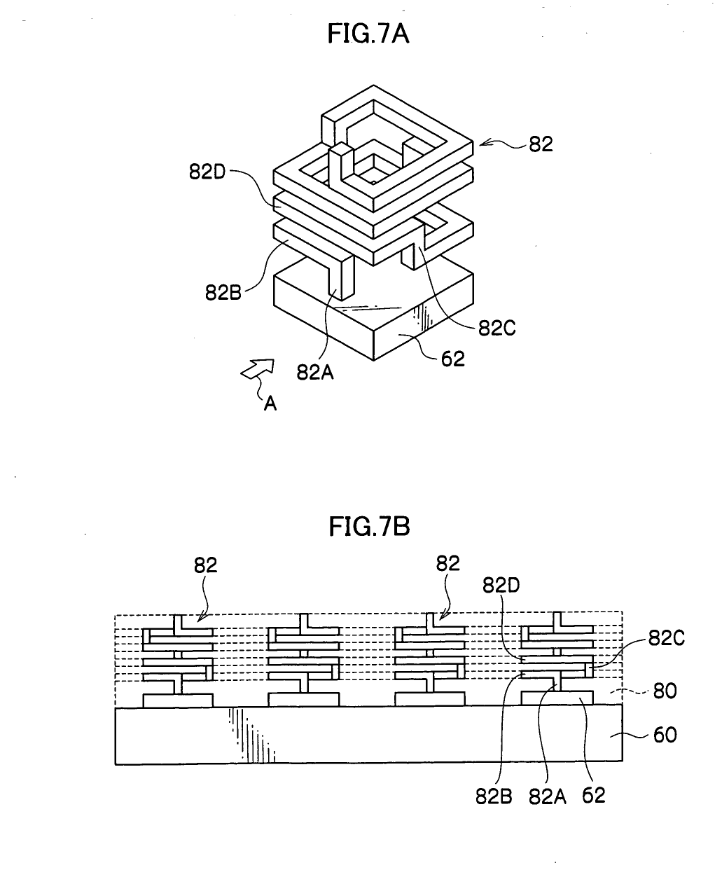

As shown in FIGS. 7A and 7B, conductive members 82 of the present embodiment are formed in spirals and manufactured by the following manufacturing method. It will be noted that FIG. 7B is a view seen from the direction of arrow A of FIG. 7A.

The electrode terminals 62 are laminated on the drive circuit substrate 60, and then a sacrifice layer 80 comprising a metal is formed. Then, the sacrifice layer 80 is patterned via an unillustrated mask, unwanted portions are removed, and conductive layers 82A are formed and planarized. Similarly, a sacrifice layer 80 is formed and patterned, and a linear conductive layer 82B is formed and planarized so as to form an incomplete enclosure (e.g., so that substantially ¾ of an enclosure is formed). Moreover, a conductive layer 82C is connected to the linear conductive layer 82B on the upper side of thereof at its end portion by repeating the same process, and a linear conductive layer 82D is connected to the upper portion thereof so as to form an incomplete enclosure (e.g., so that substantially ¾ of an enclosure is formed). As shown in FIG. 7A, spiral conductive layers 82B, 82C and 82D in which the respective layers are continuous are formed by successively forming conductive layers 82B, 82C and 82D on the sacrifice layers 80. Then, as shown in FIG. 7B, the sacrifice layers 80 are removed at once, whereby spiral conductive members 82 are completed. The conductive members 82 expand and contract in the normal line direction of the drive circuit substrate 60, and flexibility of about 1 mm is obtained.

The present invention was described in regard to specific embodiments above, but the present invention should not be construed as being limited to these embodiments. Namely, in one aspect of the invention, an inkjet recording head includes: an ejector substrate in which plural droplet ejectors are arranged, with each droplet ejector including a pressure chamber that houses ink, a drive element that acts on the ink in the pressure chamber to generate pressure waves and a nozzle which communicates with the pressure chamber and through which ink droplets are jetted; a drive circuit substrate that is disposed facing the ejector substrate and includes drive circuits that drive the drive elements to cause the ink droplets to be jetted from the nozzles; and elastic conductive members that connect the ejector substrate and the drive circuit substrate.

In the inkjet recording head of this aspect, the conductive members may be formed in spring shapes and configured so that the expansion/contraction direction of the conductive members is in a plate thickness direction of the ejector substrate.

By configuring the inkjet recording head in this manner, the conductive members are formed in spring shapes and expand/contract in the plate thickness direction of the ejector substrate. Thus, the conductive members expand/contract in the deformation direction of the drive elements of the droplet ejectors and the deformation of the drive elements can be prevented from being restricted.

In the inkjet recording head of this aspect, the drive elements of the droplet ejectors may cause the diaphragms to be displaced and act on the ink in the pressure chambers to generate pressure waves, and electrode pads connected to the conductive members may be disposed on upper portions of movable portions of the drive elements.

By configuring the inkjet recording head in this manner, the drive elements of the droplet ejectors cause the diaphragms to be displaced and act on the ink in the pressure chambers to generate pressure waves, thereby causing ink droplets to be jetted from the nozzles. In this case, the deformation of the movable portions by the drive elements is not restricted because the conductive members expand/contract even if electrode pads are disposed on the upper portions of the movable members. Thus, the diaphragms and the electrode pads are efficiently disposed, and the area of the ejector substrate (droplet ejectors) can be further reduced.

In the inkjet recording head of this configuration, the drive elements of the droplet ejectors may cause the diaphragms to be displaced and act on the ink in the pressure chambers to generate pressure waves, and the electrode pads of the drive elements connected to the conductive members may be disposed on upper portions of the pressure chambers.

By configuring the inkjet recording head in this manner, the deformation of the diaphragms by the drive elements is not restricted because the conductive members expand/contract even if electrode pads are disposed on the upper portions of the pressure chambers. Thus, the diaphragms and the electrode pads are efficiently disposed, and the area of the ejector substrate (droplet ejectors) can be further reduced.

Also, an inkjet printer can be configured to be disposed with an inkjet recording head disposed with any of the aforementioned characteristics.

By configuring the inkjet printer in this manner, the area of the ejector substrate of the inkjet recording head is reduced, the inkjet printer can be made compact, and a reduction in energy efficiency resulting from an increase in the current and load capacity can be prevented.

In the first and second embodiments, the conductive members had zigzag or spiral shapes, but the conductive members are not limited to these shapes. The conductive members can be appropriately set as long as they have elastic shapes.

The inkjet recording head described in the preceding embodiments recorded an image (including characters) on the recording medium P, but the inkjet recording head is not limited to this. Namely, the recording medium is not limited to paper, and the jetted liquid is not limited to ink. For example, the invention includes all industrially used droplet jetting apparatus, such as jetting ink onto a polymer film or glass to create display-use color filters or jetting molten solder onto a substrate to create bumps to mount parts.

What is claimed is:

1. An inkjet recording head comprising:
an ejector substrate in which plural droplet ejectors are arranged, with each droplet ejector including a pressure chamber that houses ink, a drive element that acts on the ink in the pressure chamber to generate pressure waves and a nozzle which communicates with the pressure chamber and through which ink droplets are jetted;
a drive circuit substrate that is disposed facing the ejector substrate and includes drive circuits that drive the drive elements to cause the ink droplets to be jetted from the nozzles; and
elastic conductive members that connect the ejector substrate and the drive circuit substrate.

2. The inkjet recording head of claim 1, wherein the conductive members are expandable/contractible in a plate thickness direction of the ejector substrate.

3. The inkjet recording head of claim 1, wherein the conductive members are formed in spring shapes.

4. The inkjet recording head of claim 1, wherein the conductive members are formed in zigzag shapes.

5. The inkjet recording head of claim 1, wherein the conductive members are formed in spiral shapes.

6. The inkjet recording head of claim 1, wherein each drive element includes
a movable portion,
a diaphragm that acts on the ink in the pressure chamber to generate pressure waves as a result of the movable portion being displaced toward the pressure chamber, and
an electrode pad connected to the conductive member and disposed at the opposite side from the diaphragm, with the movable portion being sandwiched between the electrode pad and the diaphragm.

7. The inkjet recording head of claim 1, wherein the drive elements include piezoelectric elements.

8. An inkjet printer disposed with an inkjet recording head, the inkjet recording head comprising:
an ejector substrate in which plural droplet ejectors are arranged, with each droplet ejector including a pressure chamber that houses ink, a drive element that acts on the ink in the pressure chamber to generate pressure waves and a nozzle which communicates with the pressure chamber and through which ink droplets are jetted;
a drive circuit substrate that is disposed facing the ejector substrate and includes drive circuits that drive the drive elements to cause the ink droplets to be jetted from the nozzles; and
elastic conductive members that connect the ejector substrate and the drive circuit substrate.

9. The inkjet printer of claim 8, wherein the conductive members are expandable/contractible in a plate thickness direction of the ejector substrate.

10. The inkjet printer of claim 8, wherein the conductive members are formed in spring shapes.

11. The inkjet printer of claim 8, wherein the conductive members are formed in zigzag shapes.

12. The inkjet printer of claim 8, wherein the conductive members are formed in spiral shapes.

13. The inkjet printer of claim 8, wherein each drive element includes a movable portion, a diaphragm that acts on the ink in the pressure chamber to generate pressure waves as a result of the movable portion being displaced toward the pressure chamber, and an electrode pad connected to the conductive member and disposed at the opposite side from the diaphragm, with the movable portion being sandwiched between the electrode pad and the diaphragm.

14. The inkjet printer of claim 8, wherein the drive elements include piezoelectric elements.

15. A droplet jetting apparatus comprising:
an ejector substrate in which plural droplet ejectors are arranged, with each droplet ejector including a pressure chamber that houses ink, a drive element that acts on the ink in the pressure chamber to generate pressure waves and a nozzle which communicates with the pressure chamber and through which ink droplets are jetted;
a drive circuit substrate that is disposed facing the ejector substrate and includes drive circuits that drive the drive elements to cause the ink droplets to be jetted from the nozzles; and
elastic conductive members that connect the ejector substrate and the drive circuit substrate.

16. The droplet jetting apparatus of claim 15, wherein the conductive members are expandable/contractible in a plate thickness direction of the ejector substrate.
